(19) United States
(12) Patent Application Publication
(10) Pub. No.: US 2014/0258995 A1
(43) Pub. Date: Sep. 11, 2014

(54) Compiler and Language for Parallel and Pipelined Computation

(71) Applicant: Steven Mark CASSELMAN, Sunnyvale, CA (US)

(72) Inventor: Steven Mark CASSELMAN, Sunnyvale, CA (US)

(21) Appl. No.: 14/198,472

(22) Filed: Mar. 5, 2014

Related U.S. Application Data
(60) Provisional application No. 61/772,968, filed on Mar. 5, 2013.

(51) Int. Cl. G06F 9/45

(52) U.S. Cl. CPC G06F 8/45
USPC 717/149

(57) ABSTRACT

A compiler and language using the comma as a parallelism operator may ensure that variables on the left hand side of a line of code are only used once, and that the variables on the left hand side of the line of code are not being used as function arguments. Commas may be replaced with semi-colons.

The current application claims a priority to the U.S. Provisional Patent application Ser. No. 61/772,968 filed on Mar. 5, 2013.

### BACKGROUND OF THE INVENTION

Some compilers have been developed for single core microprocessors. The basic syntax and semantics of compiler languages may be sequential. Microprocessors continued adding more cores thus gaining the ability to process data in parallel. To take advantage of this processing power, software engineers created thread systems which allows several chunks of sequential code to be run in parallel.

This thread capability may be in the form of a library that is linked either at compile time or run time depending on the system. These different paradigms can use the keywords embedded in comments or library functions to help the compiler to identify where it can create threads of execution that can be run in parallel. These software systems may have run time or compile time libraries. These systems may be difficult to learn and may not address the basic lack of parallel syntax and semantics in the current high level languages.

Some vendors have developed multicore architectures that have shared caches.

The ability of the hardware cores to communicate directly with each other can increase the performance of “pipelined” or “streaming” programs.

There exists therefore a need for a simple, concise, logical, portable parallel language.

### SUMMARY OF THE INVENTION

In one aspect of the invention, a method for compiling a program with task parallelism or fine grain, expression level parallelism comprises retrieving, using a computer processor, a line of code of a program; and replacing commas in the retrieved line of code with semicolons.

In another aspect of the invention, a computer program product stored on a non-transitory computer storage medium for executing pipelined parallelism comprises computer program code that when executed on a computer causes the computer to: retrieve a line of code of a program; replace commas in the retrieved line of code with semicolons; and pipeline calculations from the retrieved line of code.

In another aspect of the invention, a method for compiling a program comprises opening an input file; retrieving a line of code of a program from the input file, the line of code having multiple expressions each with a left hand side and a right hand side, wherein each expression is separated by commas; aborting the method in response to variables on the left hand side of the retrieved line of code being used more than once; aborting the method in response to one of the variables on the left hand side of the retrieved line of code being in a function of one of the multiple expressions; copying the variables on the left hand side of the program to temporary variables; replacing, with temporary variables, variables on the right hand side of the retrieved line of code; replacing variables on the left hand side by a value of a function return value for one of the variables on the right hand side of the retrieved line of code; replacing function calls in the retrieved line of code with threads; and replacing commas in the retrieved line of code with semi-colons.

### BRIEF DESCRIPTION OF THE DRAWINGS

FIG. 1 is a flowchart illustrating a typical multicore system implementing data parallelism;

FIG. 2 is a flowchart illustrating a multicore system implementing task parallelism;

FIG. 3 is a flowchart illustrating a multicore system implementing pipelined parallelism; and

FIG. 4 is a flowchart showing a method of implementing pipelined parallelism.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention relates generally to high level languages (HLL) and compilers for computer software, and more particularly to HLLs and compilers that express pipelined, multitasking and fine grained parallelism in a program.

All illustrations of the drawings are for the purpose of describing selected versions of the present invention and are not intended to limit the scope of the present invention.

In the following description, numerous specific details are set forth to provide a more thorough description of the specific embodiments. It should be apparent, however, to one skilled in the art, that the invention may be practiced without all the specific details given below. In other instances, well known features have not been described in detail so as not to obscure the embodiments. For ease of illustration, the same number labels are used in different diagrams to refer to the same items; however, in alternative embodiments the items may be different.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein. While most of the discussion will focus on Comma C (this invention) and American National Standards Institute (ANSI) C, the same ideas apply to C++, Java® and any other language.

One or more embodiments generally relate to high level languages and compilers and, more particularly, to a variant of the C and C++ languages and compilers for that language.

The current invention involves computer languages and compiler technology to enable the programmer to describe parallelism in an algorithm. The compiler interprets a little used, single character, token in the C/C++ language as the “parallelism” operator. This single character token, the comma, will be considered the token of parallelism. This is an important consideration because it a single character and it is syntactically compatible with the C/C++ language. One could use several characters or a word (e.g. “parallel”) that can be resolved into a single token but the semantics would be the same.

In an example of fine grain, expression level parallelism, a compiler may create a copy of each variable value before the evaluation of that line of code and use that value to execute the line of code. If A=5 and B=6 the line of code A=B, B=A; assigns A the value of 6 and B the value of 5 concurrently. The ANSI C evaluation would first assign A the value of 6 and then assign B the value of 6 (the new value of A). The compiler also uses the POSIX threads, or similar, API to concurrently execute functions separated by the comma operator (such as f( ), g( );).

C and C++ have syntax allows expressions, such Example 1 below, to be written. The semantics of comma C and comma C++ are different than that of the ANSI standard but the syntax is very similar. This makes the current invention very useful. If the comma operator does not exist in a language it can be added.

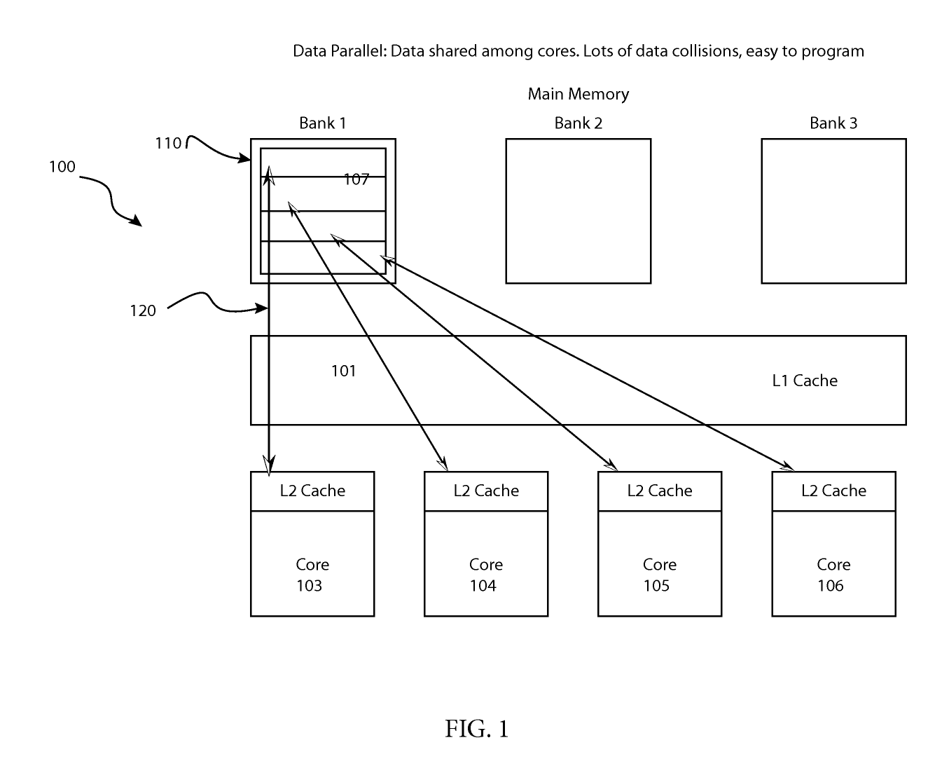

Referring to FIG. 1, data parallelism 100 is shown. FIG. 1 shows that all cores (103, 104, 105, 106) in a multicore system must go through L2 cache (101) to access main memory (110). Data parallel applications may divide up the data (107) and pass the data 107 up to each of the cores (103, 104, 105, 106). Shown are 4 bidirectional data streams 120, one for each core (103, 104, 105, 106), attempting to use one memory (110).

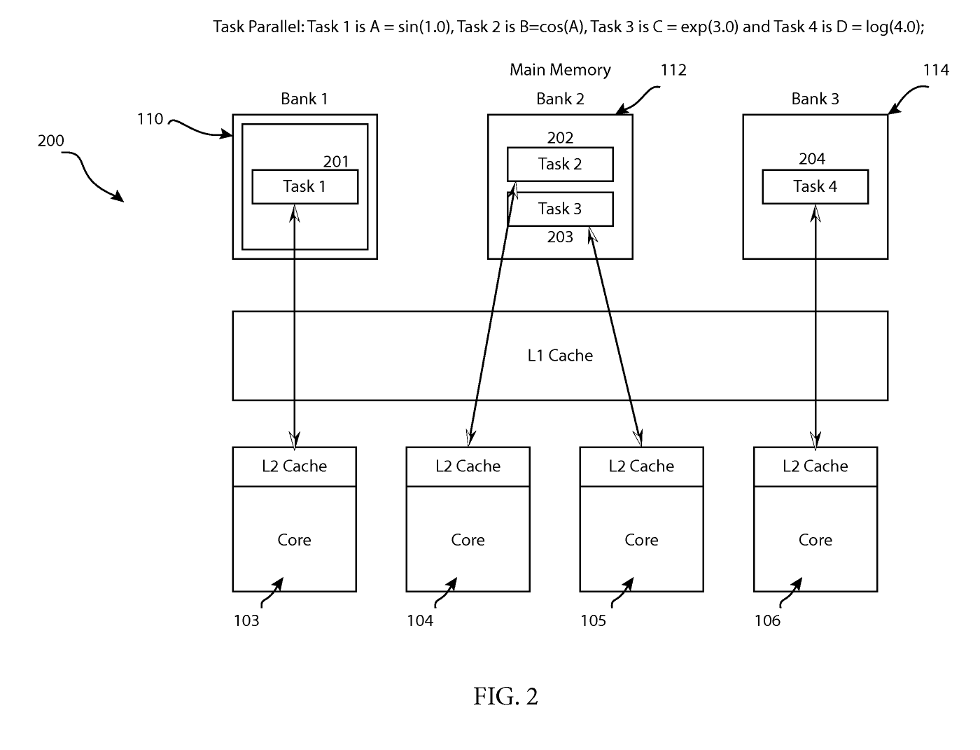

FIG. 2 shows task parallelism 200 generated by code example number 2 below. A compiler may give each function its own portable operating system interface (POSIX) thread (201, 202, 203, 204) for the four tasks (Tasks 1-4) with each thread running concurrently. This is not possible in ANSI C as the function B=cos(A) (202) would have to wait for A=sin(1.0) (201) to complete. The comma compiler may then insert code to cause the execution of the next line of code to wait until each thread returns. The compiler could do this by using the wait ( ) function in POSIX threads application program interface (API). The cores (103, 104, 105, and 106) use memory 110, 112, and 114 in parallel.

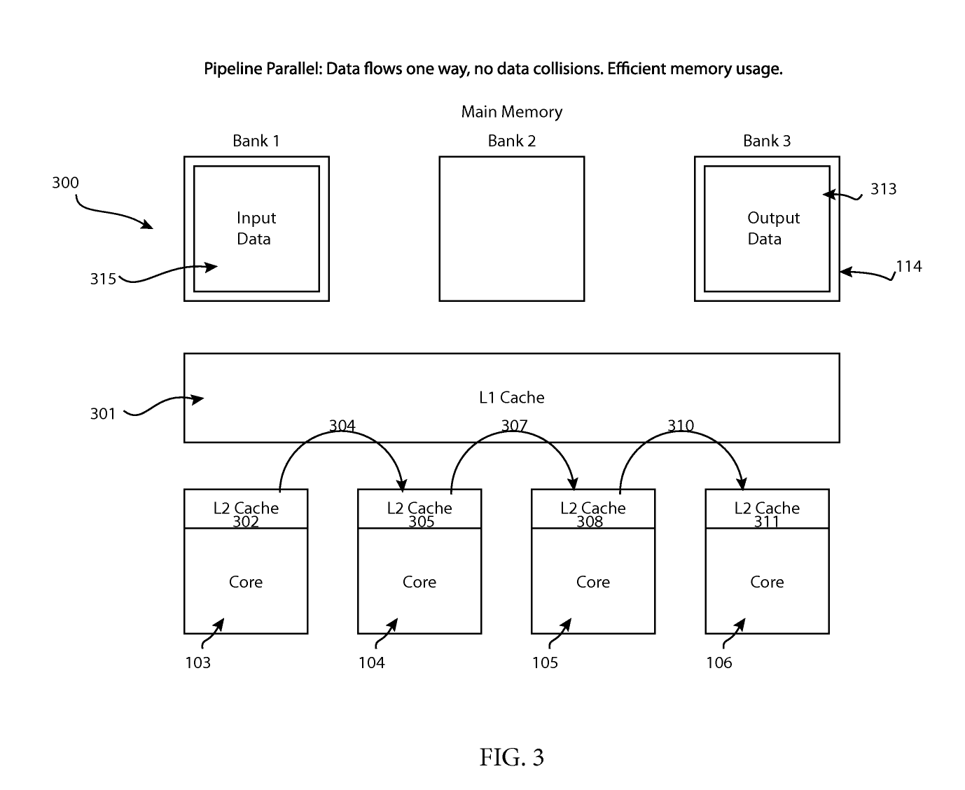

FIG. 3 shows pipelined parallelism 300 and data flow generated by code example number 3. Input data 315 may flow in a pipelined manner from a first core 103 and a first cache 302 to a first random access memory (RAM) 304. The input data 315 may flow from the first RAM 304 to a second core 104 and a second cache 305, and then to a second RAM 307. The input data may flow from the second RAM 307 to a third core 105 and a third cache 308, and then to a third RAM 310. The input data 315 may flow from the third RAM 310 to a fourth core 106, and a fourth cache 311, and then output data 313 may be output to memory 114. In a pipelined calculation there may be less chance of a resource conflict with only 2 bidirectional data streams. Cache may be used as RAM (304, 307, and 310). Each piece of cache used as RAM (304, 307, 310) can be used in many different ways to implement the pipelined code in example 3. In an embodiment, a circular buffer or a semaphore may be used to transfer data or a software first-in-first-out (FIFO) method may be used to hand off data in a pipelined fashion between the cores.

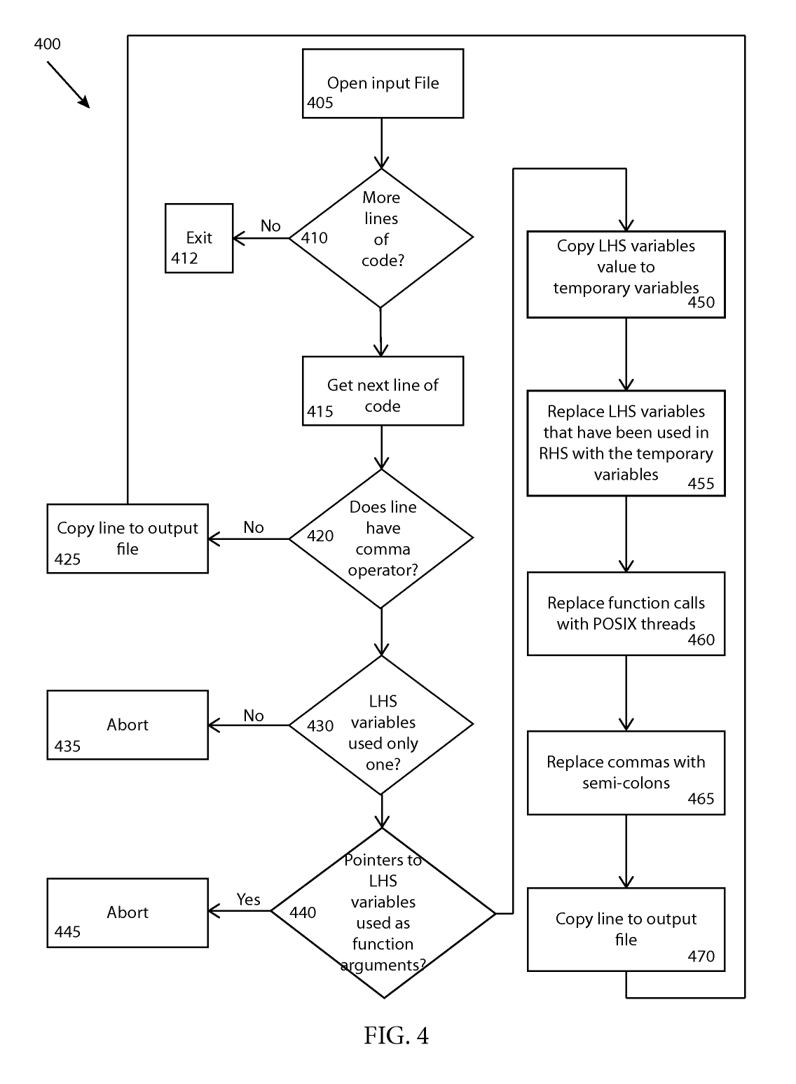

Referring to FIG. 4, a method 400 of implementing pipelined parallelism may include a step 405 of opening an input file. As an example, FIG. 4 can illustrate how to translate a comma C program in order to use a regular C compiler (see below for examples of Comma C). Code may be received and tasks created of hazard free expressions that may be scheduled concurrently. Comma C may be taken from the input file and C code may be output to an output file (see step 470 below) that may be passed to the C compiler where it may be compiled into object code. A step 410 may include checking if there are more lines of code. If there are no more lines of code, a step 412 may include exiting the method 400. If there are more lines of code, a step 415 may include retrieving a next line of code. The line of code, for example, may have multiple expressions, with each expression separated by commas. A step 420 may include checking whether the retrieved line of code has a comma operator. If the retrieved line of code does not have a comma operator, a step 425 may include copying the retrieved line of code to an output file. If the retrieved line of code does have a comma operator, a step 430 may include checking whether left hand side (LHS) variables in the retrieved line of code are only used once. If the left hand side variables in the retrieved line of code are used more than once, a step 435 may include aborting the method 400. If the left hand side variables in the retrieved line of code are used only once, a step 440 may include checking whether pointers to the left hand side variables in the retrieved line of code are used as arguments. If pointers to left hand side variables in the retrieved line of code are used as arguments, a step 445 may include aborting the method 400. For example, if one of the left hand side variables appears in a function of another expression in a list of expressions separated by commas, then the method 400 may be aborted. If pointers to the left hand side variables in the retrieved line of code are not used as arguments, a step 450 may include copying values of the left hand side variables to temporary variables. A step 455 may include replacing the left hand side variables that have been used in the right hand side of the retrieved line of code with the temporary variables (right hand side variables may be replaced with temporary variables). A step 460 may include replacing function calls with threads, such as POSIX threads. As an example, left hand side variables may be replaced by a value of a function return value of a variable on the right hand side of the retrieved line of code. A step 465 may include replacing commas in the retrieved line of code with semi-colons. A step 470 may include copying the retrieved line of code to the output file. As an example, the output file may be compiled into object code and executed.

Brief description of code examples:

Example 1: Code showing fine grain parallelism.
Example 2: Code showing multiple tasks.
Example 3: Code showing pipelined algorithm.
Example 4: Illegal race condition.

### CODE EXAMPLES

### Example 1

{
int A = 0;
int B = 1;
int C = 2;
// evaluate simultaneously
A = B+C, B = A+C; // => A = 3 and B = 2
}

### Example 2

{
float A = 0.0;
float B = 0.0;
float C = 0.0;
float D = 0.0;
// do all these in parallel
A = sin(1.0), B = cos(A), C = exp(3.0), D = log(4.0);
}

### Example 3

void
f(int a, int *b)
{
*b = a;
}
void
g(int b, int *c)
{
*c = b;
}
void
h(int c, int *d) {
*d = c;
}
main( ) {
int a = 0, b = 1, c = 2, d = 3;
printf(“a =%d, b=%d, c=%d,\
d=%d\n”,a,b,c,d);
for (a=0,a<10,a++)
f(a,&b), g(b,&c), h(c,&d),
printf(“a =%d, b=%d, c=%d,\
d=%d\n”,a,b,c,d);
}
Output:
a=0, b=1, c=2, d=3
a=1, b=0, c=1, d=2
a=2, b=1, c=0, d=1
a=3, b=2, c=1, d=0
a=4, b=3, c=2, d=1
a=5, b=4, c=3, d=2
a=6, b=5, c=4, d=3
a=7, b=6, c=5, d=4
a=8, b=7, c=6, d=5
a=9, b=8, c=7, d=6

### Example 4

{
int A = 0;
int B = 1;
int C = 1;
A = B, A = C;
}

Example 1 shows a 100% ANSI C compatible piece of code. If it were evaluated by the ANSI standard you would not be able to concurrently evaluate both expressions. The value of the variables under the ANSI standard would be A=1+2=3 and B=3+2 =5 where the value 3 has been used for A in the expression B=A+C. In comma C before the line of code, “A=B+C, B=A+C;”, A=0, B=1 and C=2. We substitute these values into the code and then solve. A=1+2=3 and B=0+2=2.

In example 2 we have four different functions in one line of code. In ANSI C these could not be evaluated concurrently since you have B=cos(A) and B has to wait for A to be evaluated before it can be scheduled. In Comma C we take the value of A before the whole line of code and pass it to the cos function. These functions can each be evaluated concurrently.

Example 3 shows how Comma C functions can be pipelined. Each of the functions is simple to show the data movements. Each of the functions just pass data from one variable to another. The functions could be executing complicated algorithms but the overall behavior would still be the same, one function passing data directly to another function in a pipelined fashion. Inside the for loop is a comma expression that show how the functions argument are linked such that the second argument of f(a,&b) feeds into g(b,&c). This allows the compiler to recognize an opportunity to pipeline this line of code.

Example 4 shows an illegal piece of Comma C code. While this code is valid in the ANSI C standard in Comma C this creates a race condition since two assignments will be concurrently trying to assign a value to the variable A. The compiler recognizes this by seeing the left hand side of an expression is the same in two or more expressions to be run concurrently.

It should be understood, of course, that the foregoing relates to exemplary embodiments of the invention and that modifications may be made without departing from the spirit and scope of the invention as set forth in the following claims.

What is claimed is:

1. A method for compiling a program with task parallelism or fine grained, expression level parallelism comprising:
retrieving, using a computer processor, a line of code of a program; and
replacing commas in the retrieved line of code with semicolons.

2. The method of claim 1, including aborting prior to the replacement of the commas in the retrieved line of code with semicolons in response to multiple variables on a left hand side of the retrieved line of code being used more than once.

3. The method of claim 1, including aborting prior to the replacement of the commas in the retrieved line of code with semicolons in response to pointers to variables on a left hand side of the retrieved line of code being used as function arguments.

4. The method of claim 1, including:
copying variables on a left had side of the retrieved line of code to temporary variables; and
replacing variables on the right hand side of the retrieved line of code with the temporary variables.

5. The method of claim 1, including creating an output file from the retrieved line of code.

6. The method of claim 5, including compiling the output file.

7. The method of claim 5, including creating object code from the output file.

8. A computer program product stored on a non-transitory computer storage medium for executing pipelined parallelism comprising computer program code that when executed on a computer causes the computer to:
retrieve a line of code of a program;
replace commas in the retrieved line of code with semicolons; and
pipeline calculations from the retrieved line of code.

9. The computer program product of claim 8, including:
computer program code configured to implement a circular buffer for implementing the pipelining of the calculations.

10. The computer program product of claim 8, including:
computer program code configured to implement a semaphore for implementing the pipelining of the calculations.

11. The computer program product of claim 8, including:
computer program code configured to implement a software first-in-first-out for implementing the pipelining of the calculations.

12. The computer program product of claim 8 including computer program code configured to:
abort prior to the replacement of the commas in the retrieved line of code with semicolons in response to variables on a left hand side of the retrieved line of code being used more than once.

13. The computer program product of claim 8, including computer program code configured to:
abort prior to the replacement of the commas in the retrieved line of code with semicolons in response to pointers to variables on a left hand side of the retrieved line of code being used as function arguments.

14. The computer program product of claim 8, including computer program code configured to:
copy variables on a left had side of the retrieved line of code to temporary variables; and
replace variables on the right hand side of the retrieved line of code with the temporary variables.

15. A method for compiling a program comprising:
opening an input file;
retrieving a line of code of a program from the input file, the line of code having multiple expressions each with a left hand side and a right hand side, wherein each expression is separated by commas;
aborting the method in response to variables on the left hand side of the retrieved line of code being used more than once;
aborting the method in response to one of the variables on the left hand side of the retrieved line of code being in a function of one of the multiple expressions;
copying the variables on the left hand side of the program to temporary variables;
replacing, with temporary variables, variables on the right hand side of the retrieved line of code;
replacing variables on the left hand side by a value of a function return value for the right hand side of the retrieved line of code;
replacing function calls in the retrieved line of code with threads; and
replacing commas in the retrieved line of code with semi-colons.

16. The method of claim 15, including:
copying the line of code with the replaced values to an output file; and
compiling the output file into object code.
